(19) United States
(12) Patent Application Publication
(10) Pub. No.: US 2011/0319248 A1
(43) Pub. Date: Dec. 29, 2011

(54) Single Use Centrifuge

(76) Inventor: Nathan Starbard, Boston, MA (US)

(21) Appl. No.: 13/225,156

(22) Filed: Sep. 2, 2011

(51) Int. Cl. B04B 7/12; B04B 15/00

(52) U.S. Cl. 494/40; 494/45

(57) ABSTRACT

The present invention relates to a device that incorporates a single use centrifuge that is sterilized prior to use in the pharmaceutical, biopharmaceutical, biotechnology or related industries and is used for the removal of solids and/or other undesirable materials from one or more fluids and is connected to a bioreactor, fermentor, container or process by way of single use tubing, connectors and/or various fluid flow components.

### TECHNICAL FIELD

The present invention concerns a device incorporating a single use centrifuge that is sterilized prior to use in the pharmaceutical, biopharmaceutical, biotechnology or related fields.

### BACKGROUND ART

Biotechnology, pharmaceutical and related industries have historically used stainless steel, or otherwise reusable, processes and devices. Re-useable processes must be cleaned and sterilized between batches. The cleaning and sterilization usually requires the use of steam and/or chemicals to accomplish the task. Additionally, for regulated products such as pharmaceuticals, the sterilization process has to be validated to show that it could repeatedly sterilize the device. The cleaning and sterilization processes and the validation are time consuming and expensive and cannot be varied without a new validation. Re-useable processes also have significantly higher startup costs in material and installation, and often require a much larger footprint.

As a result, in recent years these industries are increasingly moving towards the use of single use (disposable) containers, tubing, flow path components and ancillary equipment in their research, manufacturing and processing of sterile fluids. The use of single use devices eliminates or minimizes the need for cleaning and sterilizing equipment between batches.

Centrifuges are primarily used to clarify fluid streams downstream from fermentors or bioreactors to remove cell debris and other undesirable materials from fluid streams.

### SUMMARY

Re-usable equipment and technologies require cleaning and sterilization, increased start-up costs and costly validations. They also create difficulties for technology transfer and can limit both scalability and reproducibility.

The present invention advantageously brings the benefits of single use devices to centrifuge applications to allow the user to safely process a fluid and/or biopharmaceutical product without the risk of contamination and thereby also reducing the cleaning and/or validation costs associated with conventional methods. Technology transfer, the process of moving, transferring or duplicating processes in different locations, is made significantly easier through the use of such a device. The device also provides positive economic benefits associated with the replacement of conventional metallic wear parts with those of a less expensive polymeric composition.

### BRIEF DESCRIPTION OF THE DRAWINGS

FIG. 1 Shows a single use disc stack centrifuge with a cross-sectional view of the centrifuge bowl and stack module.

FIG. 2 Shows a cross-sectional view of a single use disc stack centrifuge with the single use portion of the centrifuge primarily comprised of the fluid inlet and outlet, inner bowl and disc stack being inserted into the opened and re-useable outer casing and connected to the re-useable portion of the rotor.

FIG. 3 Shows a cross-sectional view of the single use portion of a disc stack centrifuge and the connection point to the re-usable rotor with all or a majority of the rotor being of the re-usable type. The fluid inlet and outlet of the centrifuge are directly fashioned as aseptic connectors.

FIG. 4 Shows a cross-sectional view of the single use portion of a disc stack centrifuge and the connection point to the re-usable rotor with approximately half of the rotor being re-usable and the other half being a part of the single use device. The fluid inlet and outlet of the centrifuge consist of a tubing connector attached to sections of tubing with opposite ends of the tubing attached to separate single use aseptic connectors.

FIG. 5 Shows a locking tab configuration that may be used to connect the single use portion of the centrifuge with the re-useable portion of the centrifuge, usually at the rotor.

FIG. 6 Shows a threaded configuration that may be used to connect the single use portion of the centrifuge with the re-useable portion of the centrifuge, usually at the rotor.

FIG. 7 Shows a process in which the outlet of a flexible bioreactor is able to be connected by way of corresponding male and female aseptic connectors to a single use centrifuge. The clarified fluid outlet leaves by way of an actuated male/female aseptic connector and proceeds downstream to two flexible bioprocess containers and further downstream of the process.

### DESCRIPTION OF THE EMBODIMENTS

Current industry generally uses centrifuges formed almost entirely of a metallic composition such as stainless steel. This is primarily for the longevity and clean-ability of the centrifuge. As the present invention is designed for a single use, longevity and clean-ability are not required traits of certain components of the present invention. Polymers and plastics are appropriate materials for single use centrifuges.

In the preferred embodiment of the invention, only a portion of the centrifuge is designed for single use. The single use components of the device are primarily comprised of the fluid contact areas including the inlet(s) 8, fluid outlet(s) 9, bowl 4 and fluid contact surfaces where separation takes place 5. The motor 1, all or part of the rotor 7, outer casing 3, final solids discharge outlet 11, base and controls 2 as well as ancillary non-fluid contact components are re-used and are designed as fixed equipment, usually constructed of stainless steel.

The rotor 7 of the centrifuge rapidly turns to create the force and motion that causes the separation of solids from the liquid stream inside of the bowl 4. In the preferred embodiment of the present invention the rotor is the preferred interface between the single use and re-useable portions of the centrifuge. In one embodiment of the invention the upper portion 15 of the rotor is part of the single use portion of the centrifuge. It is attached to the lower, re-useable, portion of the rotor 16 by some means such as threads or locking tabs. The single use portion of the rotor is preferably formed of polymeric composition while the re-useable portion of the rotor is preferably formed of a metallic composition. Stainless steel or other metallic reinforcement may be used in the primarily polymeric single use portion of the rotor. In another embodiment of the present invention the rotor is entirely re-useable and of metallic construction. The re-useable rotor is attached to the single use bowl 4 and/or disc stack 5, which are of polymeric construction. The re-useable rotor is attached to the single use components by a mechanism such as threads or locking tabs to allow the rotor to turn the single use apparatus.

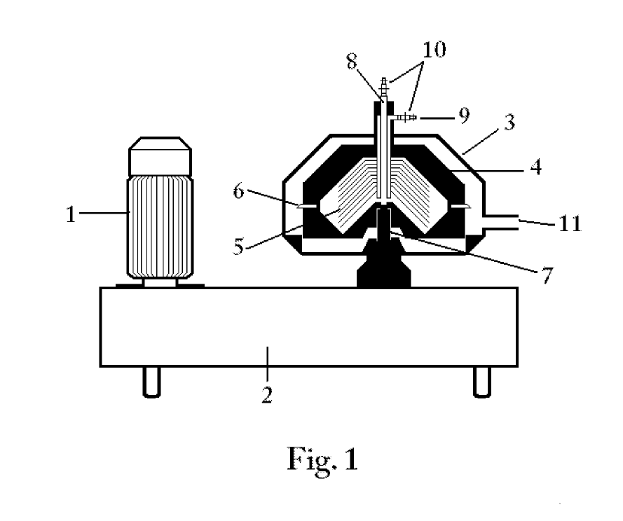

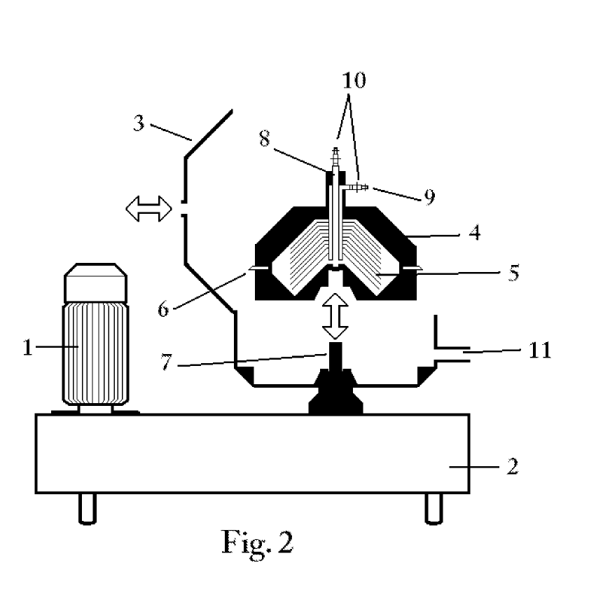

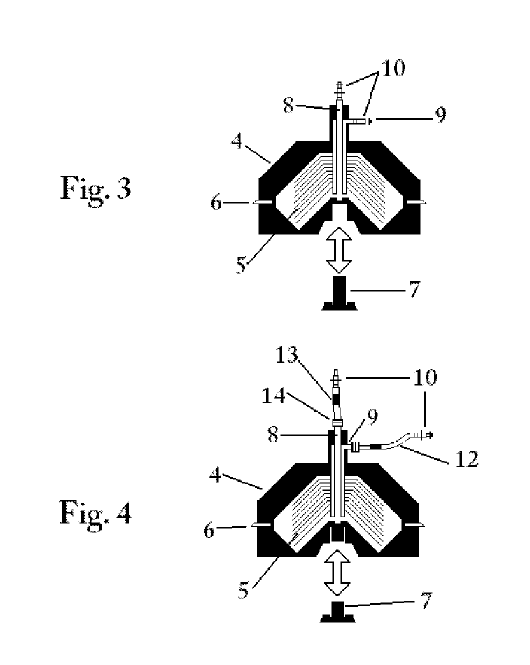

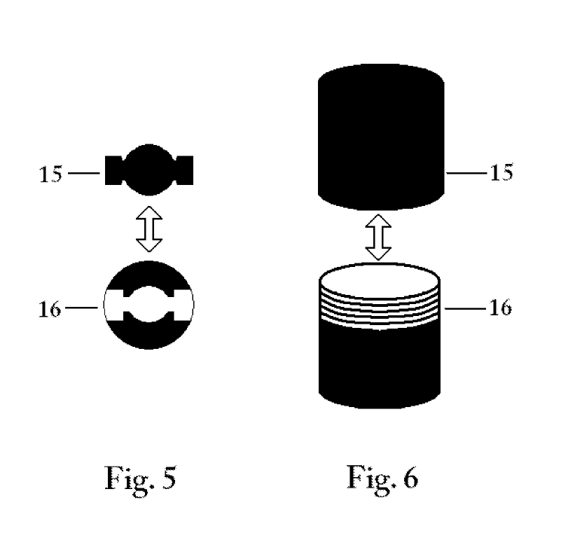

The most common centrifuge used in biopharmaceutical and related processes is the disc stack centrifuge shown in FIGS. 1, 2, 3, 4, 7. The present invention may incorporate any type of centrifuge used in biopharmaceutical, pharmaceutical, biotechnology or related industries and may be a disc stack centrifuge or other type such as decanter centrifuge. There are various adaptations known to prior art that are used in centrifuge design to increase separation capacity, speed, solids handling or to provide some other feature or benefit to the device that may be incorporated into the present invention including various plate or disc designs, baffles, spacers, the shapes of various components and so forth.

The solids are discharged from the centrifuge bowl 4 by way of a discharge port 6 with the final discharge occurring at the solids outlet 11. The port is often opened and closed by some means such as actuation when this is the case. The port may be operated in a continuous or intermittent mode. During the continuous mode of operation the solids discharge port is in the open position for most or all of the processing phase. During the intermittent mode of operation the solids discharge port is opened periodically during processing to permit the accumulated solids to discharge from the centrifuge.

The single use portions of the device of the present invention are preferably formed either entirely or predominantly of a polymeric composition such as polypropylene (PP); polyamide (PA); polyethylene terephthalate (PET); polysulfone (PS); polyethersulfone (PES); polyvinyl chloride (PVC), polycarbonate (PC), polyvinylidene fluoride (PVDF), polyetheretherketone (PEEK), polytetrafluoroethylene (PTFE), polyurethane (PU); polyethylene (including ultrahigh molecular weight polyethylene, linear low density polyethylene, ultralow, low or medium density polyethylene); ethylene vinyl alcohol (EVOH); polyvinyl acetate (PVA); ethylene vinyl acetate (EVA); ethylene vinyl acetate copolymers; films and multilayered laminates of different thermoplastics; as well as other polymers and plastics (including thermoplastic polymers, thermoplastic elastomers, homopolymers, copolymers, block copolymers, graft copolymers, random copolymers, alternative copolymers, terpolymers, metallocene polymers) and derivatives or mixtures thereof. Such materials are available from a wide range of chemical manufacturers. Metals, including stainless steel, titanium and aluminum, may also be used to form all or a part of the single use components of the invention. Metals, primarily stainless steel, are used to construct the re-useable fixed equipment of the present invention that may include the rotor 7, motor 1, outer casing 3, base and controls 2 and so forth. Flow to the device is generally provided by a pump 18.

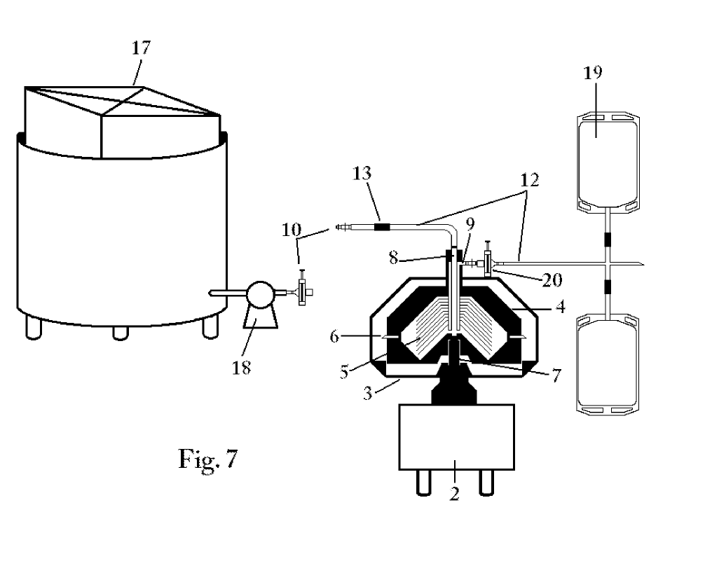

In the preferred embodiment of the present invention the centrifuge is incorporated with or used in conjunction with aseptic (sterile) connectors 10, 20 such that the device may be attached to a process or container without the risk of contamination or use of a special area or procedure, such as under a hood in a clean room. Aseptic connectors are increasingly used within industry to connect containers 17, 19, sampling devices, filters, tubing 12, sections of a process and so forth. Aseptic connectors are available from a variety of suppliers to the pharmaceutical and biotechnology industries including Sartorius Stedim Biotech SA of France; Colder Products Company of St. Paul, Minn.; Millipore Corp. of Billerica, Mass.; Pall Corp. of Port Washington, N.Y. and GE Healthcare of Fairfield, Conn. The centrifuge may directly incorporate aseptic connectors as its inlet and outlet, as shown in FIG. 1. In this embodiment the connectors may be formed as part of the centrifuge or permanently attached directly to the centrifuge. The centrifuge may also indirectly incorporate aseptic connectors such as when they are attached via tubing 12 and/or fluid flow components or connectors 14 to the centrifuge inlet(s) and/or outlet(s) as shown in FIG. 7. Fluid flow components and fittings that may be used in the path of the inlets and/or outlets of the device may include connectors such as Luer, Colder or other such connectors common to industry, valves, clamps, tees, hose barbs, sanitary connections and so forth.

The preferred embodiment of the present invention uses aseptic (sterile) connectors 10, 20 that are initially a closed system to allow for device unpackaging and attachment while maintaining sterility. Such connectors include the Lynx Connector from Millipore Corp.; the Opta Connector from Sartorius Stedim Biotech SA; the ReadyMate Connector from GE Healthcare; the Kleenpak Connector from Pall Corp.; and so forth. These connectors are of a design such that the disconnected ends are initially a sterile barrier. There are two matching pieces of the connector with one being attached to a device or process and the other being attached to the item desired to be connected, in this case the device of the invention. Upon combining the two ends of the connector the flow path is generally opened by way of some means such as actuation, use of a membrane barrier and so forth. The fluid flow path is not exposed and therefore remains sterile.

In addition to being a unique device connected to a container or process, another embodiment of the present invention is a single use centrifuge pre-connected to a part of the process, such as a container or bioreactor, by way of tubing, flow path components or connectors. The entire section of the process including the container, the present invention and other ancillary components such as filters, sampling devices, additional tubing, sensors and so forth are sterilized together through a method such as irradiation. An aseptic connector may not be required in this embodiment as the invention is already connected to the process or container prior to sterilization. This embodiment is most applicable when using an entirely disposable polymeric flow path.

The present invention is most commonly sterilized by exposure to irradiation. The two forms of irradiation most commonly used in the pharmaceutical and biotechnology industries for sterilization are exposure to gamma rays and cathode rays, also called electron beams or e-beams. X-rays and ultraviolet (UV) light are other sources of radiation that may also be used in some instances. Exposure to ethylene oxide (ETO) and autoclaving may also be used for sterilization. The present invention may be sterilized through a combination of techniques. For example, an irradiated centrifuge may be fitted with autoclaved connectors or tubing assemblies under a hood. The preferred embodiment of the invention is that in which the single use portion of the centrifuge is assembled with aseptic connectors 10, tubing 12, instrumentation, flow path components 13, 14 and other material requirements of the application prior to the entire device being sterilized, usually by gamma irradiation.

Materials have different levels of compatibility with respect to exposure to irradiation. Many materials turn brittle, discolor or crack following exposure to irradiation used for sterilization. Materials may be altered or blended to increase the contact dosage able to be applied. An irradiation compatible material is one that is able to perform its intended function following sterilization by irradiation. As the intended function may differ, a material may be considered compatible for one application of the device, while not compatible for another application. Furthermore, some materials may be more or less affected by one form of irradiation used for sterilization than another.

The preferred method of manufacturing the device is by molding the individual components of the centrifuge prior to joining the components together. Additional components such as tubing assemblies, single use containers, fluid flow components and aseptic connectors not fully incorporated as part of the device are then added. The device should be manufactured or assembled in a clean room or otherwise sterile environment so as to minimize the introduction of contaminants and particulates. The device is then bagged and/or sealed and sterilized.

The invention may be wirelessly enabled. The wireless communications device may be a RFID tag having a communication and storage or memory component or other wireless devices such as Bluetooth or Zigbee wireless enabled communications devices. By wirelessly enabling the device one can track the device history or important information, such as manufacture date, lot number, shelf life, sterilization date and the like. The invention may incorporate a method of tubing disconnection such as a crimping 13 or cutting component or method designed to remove all or a part of the device from the process or container to which it is connected or to remove a piece or component of the device from itself.

### REFERENCE SIGNS LIST

1—Motor
2—Base, controls, stand, electrical and other fixed equipment
3—Outer casing
4—Inner bowl
5—Disc stack
6—Solids discharge port
7—Rotor
8—Fluid inlet
9—Clarified fluid outlet
10—Aseptic connector
11—Solids outlet
12—Tubing
13—Crimp or cut tubing disconnect
14—Tubing connector
15—Upper rotor portion (to bowl/disc stack)
16—Lower rotor portion (to base, housing, fixed equipment)
17—Flexible bioreactor
18—Pump
19—Flexible bioprocess container or sampling bag
20—Actuated aseptic connector with joined male and female ends

1. A device primarily comprised of a single use centrifuge;
wherein said device is attached to a process, bioreactor, fermentor or other container by way of tubing, fluid flow components and/or connectors including aseptic connectors and;
wherein at least a portion of the device is sterilized prior to use by irradiation, exposure to ethylene oxide, autoclaving or a combination thereof and;
wherein the device is used for the separation of material from one or more fluid streams in the biopharmaceutical, biotechnology, pharmaceutical or related industries.

2. When the centrifuge of claim 1 incorporates a combination of both single use and re-useable components.

3. When the device of claim 1 is connected to a container, fermentor, bioreactor or process by an aseptic connector.

4. When the centrifuge of claim 1 incorporates one or more fluid inlets and/or fluid outlets that are aseptic connectors or function as aseptic connectors.

5. When the device of claim 1 is connected to a container, fermentor, bioreactor or process prior to sterilization of the newly formed device or process by irradiation, exposure to ethylene oxide, autoclaving or a combination thereof.

6. When the single use components of the device of claim 1 are primarily formed of a polymeric composition.

7. When the device of claim 1 incorporates a method of cutting, crimping or other method of detachment of polymeric tubing that is attached to the device or incorporated as part of the device.

8. When the device of claim 1 is wirelessly enabled.

9. When the rotor of the centrifuge of claim 1 is attached to the bowl of the centrifuge of claim 1 by a mechanism such as one or more locking tabs, threads or a comparable method used to attach components.

10. When the rotor of the centrifuge of claim 1 is attached to the disc stack of the centrifuge of claim 1 when said centrifuge is of the disc stack type by a mechanism such as one or more locking tabs, threads or a comparable method used to attach components.

11. When a part of the rotor of the centrifuge of claim 1 is attached to another part of the rotor of the centrifuge of claim 1 by a mechanism such as one or more locking tabs, threads or a comparable method used to attach components.

12. When the device of claim 1 uses a method such as an adhesive, membrane or polymeric seal to maintain a closed barrier at the centrifuge solids discharge port(s).

13. When the device of claim 1 is used in conjunction with a previously re-useable centrifuge modified to accept single use components consistent with the device of claim 1.
